(19) United States
(12) Patent Application Publication
(10) Pub. No.: US 2007/0245072 A1
(43) Pub. Date: Oct. 18, 2007

(54) Pre-switching register output signals in registered memory modules

(76) Inventor: Siva Raghuram, Germering (DE)

Correspondence Address: EDELL, SHAPIRO & FINNAN, LLC, 1901 RESEARCH BLVD., SUITE 400, ROCKVILLE, MD, 20850, US

(21) Appl. No.: 11/384,837

(22) Filed: Mar. 21, 2006

(51) Int. Cl. G06F 13/00

(52) U.S. Cl. 711/105; 711/167

(57) ABSTRACT

Pre-switching of output signals of a register within a registered memory module is described herein. The register receives a plurality of signals at respective input terminals, and the register stores the input signals in response to transitions of a clock signal. The register further includes output terminals on which the stored input signals are present as high or low level output signals. The high and low level output signals of the output terminals are applied to a plurality of memory devices. The high and low level output signals, which are present on the output terminals, are pre-switched to intermediate level signals having a signal height greater than that of the low level output signal and less than that of the high level output signal. The pre-switching occurs between following transitions of the clock signal determined for storing the input signals.

### FIELD OF THE INVENTION

The present invention relates to registered memory modules, such as registered dynamic random access memory (“DRAM”) modules, and more particularly is concerned with a method of pre-switching register output signals in registered memory modules.

### BACKGROUND

Registered memory modules such as registered DRAM modules are commonly used in a large variety of different applications, particularly as system memory in computer systems. In these applications, speed and capacity demands on DRAM modules continue to increase. However, in registered DRAM modules which include registers for driving the DRAMs on the module, high capacitive loads of register output terminals may increase input-output propagation delay time of the signals passing through the register and may thus cause a severe obstacle to the desired speed increase. Particularly, with conventional technology, while raising the frequency of a clock signal for operating the DRAM module, a problem may occur such that it is no longer possible to drive all the DRAMs of the DRAM memory module within a single clock period.

### SUMMARY

The invention reduces input-output propagation delay time of signals passing through the registers, included in registered memory modules for driving of memory devices, via a method of pre-switching register output signals and a registered memory module adapted to perform the pre-switching method.

In accordance with the present invention, a method of pre-switching, or pre-shifting, register output signals is provided, wherein each of the registered memory modules comprises at least one register and a plurality of memory devices, such as DRAM devices, that are connected to register output terminals. Each register receives a plurality of signals at respective input terminals and stores or latches these input signals which are responsive to a transition of a clock signal thus making the input signals present on the register output terminals to be applied to the memory devices as output signals. The clock signal may be an internal clock signal, e.g., generated by a phase-lock loop (“PLL”) from an external clock signal, which is applied to the registered memory module through a dedicated clock line. Adjacent transitions of the clock signal, that are determined for storing of the input signals, e.g., each raising edge, each falling edge, or each raising and each falling edge of the clock signal, respectively define a clock period.

On the register output terminals, output signals are present as high and low level output signals, i.e., logic high and low values that may represent “logic ones” and “logic zeros”, based on the stored input signals applied to the register input terminals.

Furthermore, during a transition of the clock signal selected for storing of input signals, the input signals applied to the register input terminals are stored in the register and are present on the output terminals as high or low level output signals with regard to the respective input signals. During the following transition of the clock signal determined for storing of the input signals, the high level output signals, present on the register output terminals, are switched to low level output signals, and low level output signals are switched to high level output signals, otherwise the output signals remain unchanged.

According to the invention, during each clock period of the clock signal, before the next output signals are made present on the output terminals of the register, low level output signals and high level output signals on the output terminals of the register are pre-switched, or pre-shifted, to intermediate signals having a signal height greater than that of the low level output signal and less than that of the high level output signal.

During the following transition of the clock signal determined for storing of input, starting from the intermediate level signals, register output signals on the register output terminals are switched to high level output signals or low level output signals with regard to the input signals applied on the input terminals. Since the time required for switching from an intermediate level to either a high or a low level is less than that of switching from a high to a low level or from a low to high level, the switching time (ι_{PD}) is reduced.

According to an embodiment of the method of the invention, within each clock period of the clock signal, a low level output signal and a high level output signal are both pre-switched to intermediate signals having a signal level, or signal height, determined by the signal height of the low level output signal and approximately half an absolute difference between the signal heights of the low level and the high level output signals. Hence, pre-switching the output signals of the register output terminals, the low level output signals and the high level output signals are pre-switched to an approximate middle position between the high and low level output signals.

In accordance with another embodiment of the invention, a registered memory module includes a register and comprises input terminals to receive a plurality of signals, output terminals on which the stored input signals are present, and a plurality of memory devices connected to the output terminals of the register. The registered memory module further comprises a pre-switching unit to pre-switch within each clock period of the clock signal, low level output signals and high level output signals to intermediate signals having a signal height greater than that of the low level output signal and less than that of the high level output signal. The registered memory module further comprises: a controlling unit for controlling the pre-switching unit.

The above and still further features and advantages of the present invention will become apparent upon consideration of the following detailed description of specific embodiments thereof, particularly when taken in conjunction with the accompanying drawings.

### BRIEF DESCRIPTION OF THE DRAWINGS

FIG. 1 schematically depicts an embodiment of a registered DRAM memory module according to the invention;

FIGS. 2A and 2B diagrammatically depict register output signals, wherein FIG. 2A illustrates conventional register output signals without pre-switching of the register output signals within clock periods, and wherein FIG. 2B illustrates register output signals according to the invention with pre-switching of the register output signals within clock periods;

FIGS. 3A and 3B diagrammatically depict simulations showing the switching time reduction using pre-switching compared to conventional switching.

### DETAILED DESCRIPTION

Embodiments of the present invention will be described in detail below with reference to the accompanying drawings.

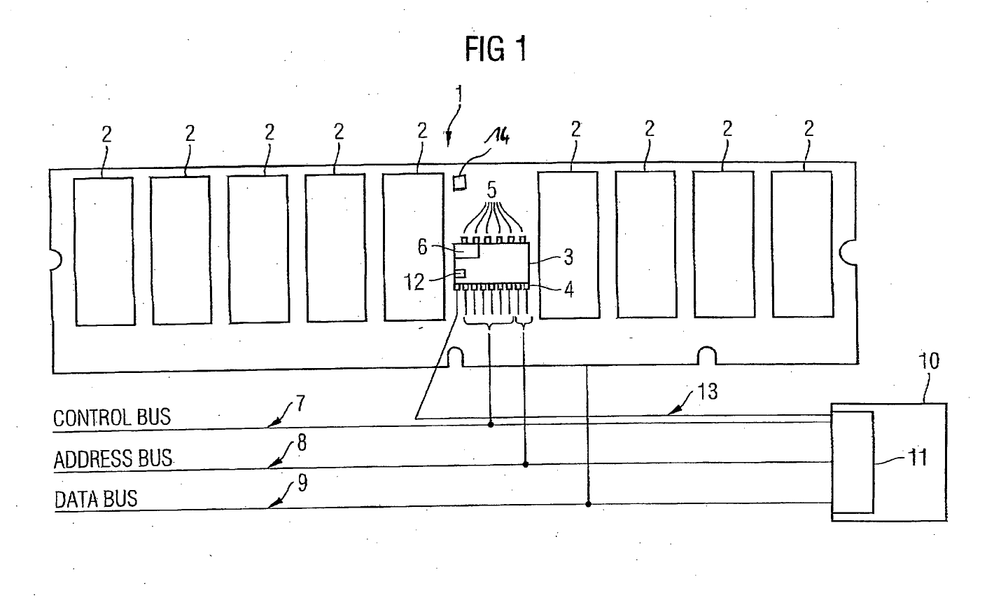

FIG. 1 depicts an embodiment of a registered DRAM memory module according to the invention. Accordingly, a registered DRAM memory module (1) includes nine DRAM memory devices (2), although a greater or smaller number of DRAM memory devices may be included in the registered DRAM memory module of FIG. 1. The DRAM memory module (1) also includes a register (3) that receives control signals connected through a control bus (7) and address signals connected through an address bus (8) on input terminals (4). While six input terminals for input control signals and two input terminals for input address signals are shown in the DRAM memory module of FIG. 1, the register (3) can include a larger or smaller number of input terminals.

The control and address signals are latched in the register (3) and respond to an input clock signal. This input clock signal is generated by a phase-lock loop (12) from an external clock signal which is applied to the DRAM memory module (1) through a clock line (13).

Data signals, e.g., corresponding to a 64-/12-bit data word, are applied to the DRAM memory module (1) through a data bus (9).

Control bus (7), address bus (8), data bus (9) and clock line (13) are connected to a memory controller (11) which is part of a system controller (10) that controls the DRAM memory module (1).

In the register (3) of the DRAM memory module (1) of FIG. 1, each of the control and address signals that are applied to the register (3) are applied to the data inputs of respective flip-flops that are clocked by the input clock signal. However, the data that is retrieved from the register responds to the internal clock signal generated by the phase lock loop (12). Conventionally, another phase lock loop (PLL) (14) is present on DIMMs, which is used for synchronizing all timings of all the components of the DIMMs.

The signals applied to flip-flops may, for example, be latched on each rising edge of the input clock signal to the register. The latched signals are then present on output terminals (5) of the register (3) to be applied to the DRAMs (2). The PLL clock inside the register is earlier than the input clock signal to the register.

According to the invention, the register (3) used in the DRAM memory module (1) further includes a pre-switching unit (6) that pre-switches, during each clock period of the clock signal, each low level output signal and each high level output signal to an intermediate signal having a signal height, or signal level, greater than that of the low level output signal and less than that of the high level output signal. Such a pre-switching unit (6) can be realized, for instance, by switching the data out of the register earlier, via PLL clock signals generated on the register, even before data is available at the input of the register.

The register (3) used in the DRAM memory module (1) may further include a controlling unit to control the pre-switching unit (6) that pre-switches the register output signals.

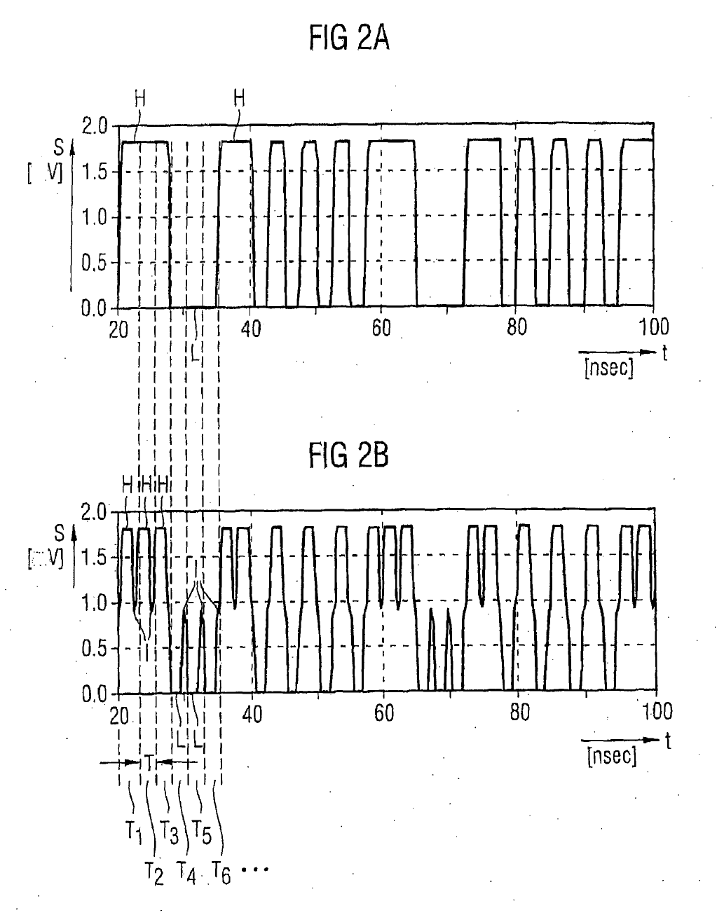

FIG. 2A illustrates conventional register output signals of a single output terminal without pre-switching the register output signals. FIG. 2B illustrates register output signals (S) of a single output terminal (5) of the register (3) used in DRAM memory module (1) shown in FIG. 1. A same data signal pattern is used in both FIGS. 2A and 2B, in other words, the register output signals are based on the same register input signals. In FIGS. 2A and 2B register output signal height (S), given in Volts (V), is drawn against time (t), given in nanoseconds (nsec).

For the purpose of illustration only, the first six clock signal periods (T) starting from (T₁) through (T₆) are described. Accordingly, in the conventional case shown in FIG. 2A, based on the input signals applied to the register input terminals, during the first three clock periods (T₁), (T₂), (T₃), output signal (S) of the register output terminal concerned is a high level output signal shown as logic high signal (H) which amounts to about 1.8 mVolts. Still in the conventional case, during the next three clock periods (T₄), (T₅), (T₆), output signal (S) of the register output terminal is a low level output signal shown as logic low signal (L) which amounts to 0 mVolts.

Compared thereto, according to an embodiment of the present invention shown in FIG. 2B, using the same data signal pattern as shown in FIG. 2A, starting from a logic high signal (H), during the first clock period (T₁), logic high signal (H) is pre-switched to an intermediate level signal (I) which amounts to about 0.9 mVolts. Thus, the register output signal (S) is pre-switched from the logic high signal (H) to an intermediate signal having a signal height approximately halfway between the logic high signal (H) and the logic low signal (L). Then, at the end of the first clock period (T₁), or during the next transition of the clock signal, determined for storing of the input signals, intermediate height signal (I) is switched back to the logic high signal (H) as is the case in the data signal pattern shown in FIG. 2A. Subsequently, the steps of pre-switching the register output signal (S) to the intermediate level signal (I) within the clock period and switching back of the register output signal to the logic high signal (H) are repeated once in the next clock period (T₂). Subsequently, during the third clock period (T₃), logic high signal (H) is pre-switched to the same intermediate level signal (I) as during the first clock period (T₁) and, during the next transition of the clock signal at the end of the third clock period (T₃), intermediate level signal (I) is switched to the logic low signal (L) according to the signal pattern as shown in FIG. 2A. Subsequently, during the fourth clock period (T₄), logic low signal (L) is pre-switched to the same intermediate level signal (I) as during the first clock period (T₁), and, at the end of the fourth clock period (T₄), intermediate height signal (I) is switched back to the logic low signal (L). Subsequently, the steps of pre-switching the register output signal (S) to the intermediate level Signal (I) and switching back of the output signal to the logic low signal (L) is repeated once in the next clock period (T₅). Subsequently, within the sixth clock period (T₆), logic low signal (L) is pre-switched to the same intermediate height signal (I) as within the first clock period (T₁) and, at the end of the sixth clock period (T₆), intermediate level signal (I) is switched to the logic high signal (H) according to the signal pattern as shown in FIG. 2A. During the following clock periods of the clock signal, within each clock period, the output signals of the register output terminal are switched to the intermediate level signal (I), and, at the end of each clock period during the next transition of the clock signal, are switched to the low level or high level signals according to the signal pattern as shown in FIG. 2A.

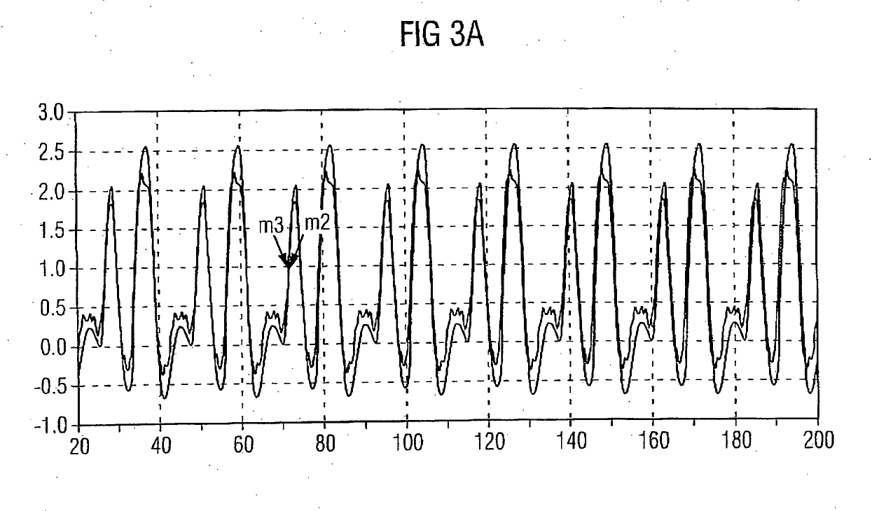

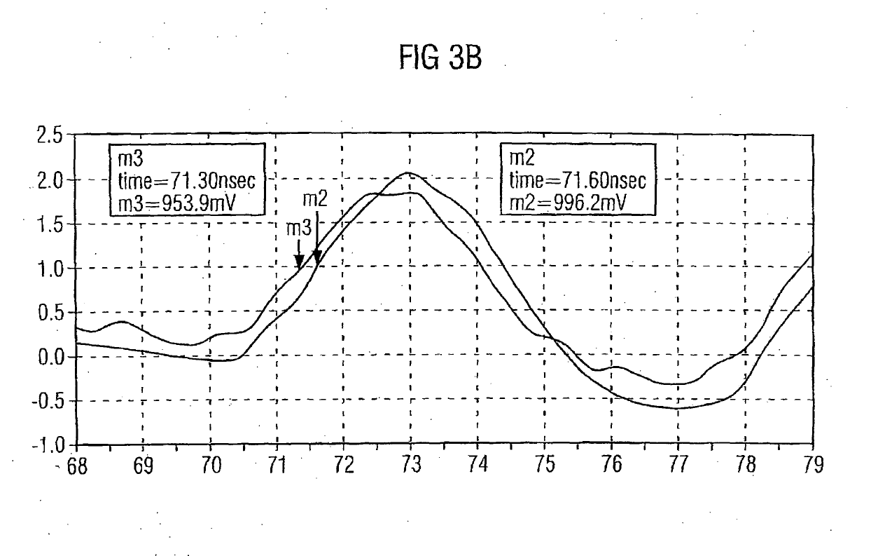

FIGS. 3A and 3B, show the simulation results. The gain in switching time by using pre-switching is shown in simulation results 3B.

While the invention has been described in detail and with reference to specific embodiments thereof, it will be apparent to one skilled in the art that various changes and modifications can be made therein without departing from the spirit and scope thereof. Accordingly, it is intended that the present invention covers the modifications and variations of this invention provided they come within the scope of the appended claims and their equivalents.

### REFERENCE LIST

1 DRAM memory module
2 DRAM memory device
3 Register
4 Input terminal
5 Output terminal
6 Pre-switching Unit
7 Control bus
8 Address bus
9 Data bus
10 System controller
11 Memory controller
12 PLL on register
13 Clock line
14 PLL external to register

What is claimed is:

1. A method of pre-switching output signals of a register provided in a registered memory module, the method comprising:
receiving a plurality of signals at respective input terminals of the register;
storing the input signals, in response to transitions of a clock signal;
providing the stored input signals as high level output signals or low level output signals to output terminals of the register;
applying the high or low level output signals present at the output terminals of the register to a plurality of memory devices; and
pre-switching the high and low level output signals present at the output terminals to intermediate signals that have a signal height less than a signal height of the high level output signal and greater than a height of the low level output signal, wherein the pre-switching occurs between each successive storing of the input signals in response to transitions of the clock signal.

2. The method of claim 1, wherein the high and low level output signals present on the register output terminals are pre-switched to intermediate level signals having a signal height that is determined as the sum of the signal height of the low level output signal and half an absolute difference between the signal heights of the high and low level output signals.

3. A registered memory module comprising:
a register including a plurality of input terminals to receive a plurality of signals, a storage module to store the input signals in response to transitions of a clock signal, and a plurality of output terminals to receive the stored input signals as high level output signals or low level output signals;
a plurality of memory devices connected to the output terminals of the register so as to receive the high and low level output signals present on the output terminals of the register; and
a pre-switching unit that pre-switches the high and low level output signals that are present on the output terminals to intermediate signals having a signal height less than a height of the high level output signal and greater than a height of the low level output signal, wherein the pre-switching unit pre-switches the high and low level output signals to intermediate signals between successive storing of input signals at the storage module of the register in response to transitions of the clock signal.
